(19) United States
(12) Patent Application Publication
(10) Pub. No.: US 2004/0232133 A1
(43) Pub. Date: Nov. 25, 2004

(54) Cooking appliances, cooking appliance door and method for producing a door pane for the cooking appliance door

(75) Inventors: Klemens Roch, Trostberg (DE); Michael Wagner, Grabenstatt (DE)

Correspondence Address: John T. Winburn, BSH Home Appliances Corporation, 100 Bosch Blvd., New Bern, NC, 28562, US

(73) Assignee: BSH Bosch und Siemens Hausgerate GmbH, Munich (DE)

(21) Appl. No.: 10/795,099

(22) Filed: Mar. 5, 2004

(30) Foreign Application Priority Data
Sep. 7, 2001 (DE) 10143925.3
Sep. 6, 2002 (WO) PCT/EP02/10000
Sep. 6, 2002 (WO) 03/023287 A1

(51) Int. Cl. F27D 11/00

(52) U.S. Cl. 219/393; 126/190

(57) ABSTRACT

A cooking appliance door and a method for producing a door pane for the cooking appliance door. The cooking appliance door has improved strength and heightened resistance to pyrolysis operation heat stress. The door pane for the appliance door includes a thermally pre-stressed borosilicate sheet glass door pane supported by a front muffle frame of the cooking appliance.

The present invention relates to a cooking appliance, in particular with pyrolysis operation, and a cooking appliance door for closing a cooling compartment of a cooking appliance muffle open to the front. The present invention further relates to a method for producing a door pane for the cooking appliance door, which is supported on a frontal muffle frame of the cooking appliance muffle when the cooking appliance door is closed. The door pane is made from an even, i.e. not embossed, thermally pre-stressed borosilicate sheet glass, which has an enamel layer, whereof the proportion of area on the door pane is between 0 and 10%.

In general, cooking appliances with pyrolysis operation are known, provided with a full glass door with at least an inner pane. When the full glass door is closed the inner pane is supported on a frontal muffle frame of a cooking appliance muffle, and is made from a flat, thermally pre-stressed borosilicate sheet glass, for example. The inner pane has an enamel layer, barring a view of the interior of the full glass door, as viewing protection for an operator.

DE 199 508 19 discloses a baking oven door-glass pane, which has a camber, i.e. a preset bulging of the glass pane, for preventing fractures and noise. The cambering of the glass pane can be controlled and brought about during manufacture of the glass pane by targeted cool air distribution during a cool-down process, whereby this targeted cool air distribution results in corresponding glass pre-stressing, through which the glass pane has the camber in the cooled state.

The object of the present invention is to provide a cooking appliance, a cooking appliance door and a method for manufacturing a door pane for the cooking appliance door, through which the door pane has improved impact strength and heightened resistance to heat stress, in particular in pyrolysis operation.

The task according to the present invention is solved by a cooking appliance having the features of Claim 1, by a cooking appliance door as claimed in Claim 7, and by a method having the features of Claim 8.

According to the present invention the cooking appliance door has at least a glass door pane, which is supported on a frontal muffle frame of the cooking appliance muffle when the appliance door is closed. The glass door pane consists of flat, thermally pre-stressed borosilicate sheet glass. Door panes of borosilicate glass are preferably used in cooking appliances with pyrolysis operation, because their heat expansion coefficient is advantageously low and borosilicate glass represents a cost-effective alternative to transparent glass ceramic (“ROBAX”), whereof the heat expansion coefficient is lower still than that of the borosilicate glass. The door pane is thermally pre-stressed to increase the impact strength and resistance to heat stress. Thermal pre-stressing of the door pane occurs through the door pane being introduced to apparatus, in which it is heated rapidly on the surface to approximately 150° C. above transformation temperature. In the range of transformation temperature a sub-cooled glass melt transitions from the viscous state to the elastic state. Immediately after this the glass is blown with cold air by a system of nozzles adapted to its shape. As a result of the rapid cooling of the glass surface the latter is frozen in an expanded grid, while the glass interior cools slowly and has to bond more strongly. Since surface and interior of the glass are interconnected, there arises in the surface layer a pressure pre-stress and in the interior a tensile pre-stress, resulting in thermal pre-stress of the glass. In addition, the door pane according to the present invention has an enamel layer as layer protection from unwanted observation into partial areas of the door. The proportion of area of the enamel layer on the door pane is restricted according to the present invention to a value between 0 and 10%. With this restricted proportion of area the enamel layer fulfils its purpose as layer protection for an operator. The disadvantageous influence of the enamel layer on the surface structure of the door pane is also sharply reduced. For this reason impact strength and resistance to heat stress of the door pane in pyrolysis operation are advantageously increased.

If a blow is delivered to a side of the door pane it is an advantage for good impact strength of the door pane if the enamel layer is applied to the surface of those door pane sides, to which the blow is delivered. In a preferred configuration of the invention the enamel layer is accordingly arranged on the side of the door pane facing the cooking appliance muffle.

According to a further advantageous design of the invention a proportion of area of the optionally coloured enamel layer, which, when the baking oven door is closed, is inside a muffle seal arranged between the door pane and the muffle frame, is maximum 5%. In particular this proportion of area of the enamel layer is reduced to 0% and the enamel layer is arranged outside a bearing position of the muffle seal. When the cooking appliance door is closed this prevents the enamel layer from being arranged inside the cooling compartment, or at least the portion of the enamel layer limited inside the cooling compartment. By way of advantage, possible evaporation of contaminants from the coloured enamel layer to the cooling compartment is either prevented or sharply reduced.

So that the danger of possible evaporating of contaminants in the cooling compartment is further decreased, the enamel layer is arranged preferably on the side of the door pane averted from the cooking appliance muffle. But this effectively reduces the impact strength of the door pane. In the interests of limiting such reduction in impact strength of the door pane, it is thus particularly advantageous if the proportion of area of the enamel layer on the side averted from the cooking appliance muffle is between 0 and 5%.

So that on the one hand the largest possible surface of the door pane is faced by means of the enamel layer for an operator and on the other hand the proportion of area of the enamel layer is reduced as much as possible, the enamel layer is not designed full-surface on the door pane according to a preferable configuration, but as a grid structure, approximately in the form of a raster pattern or a line pattern.

The conventional method for manufacturing the door pane according to the present invention is for the case where the proportion of area of the enamel layer on the door pane is 0%, and a printing procedure for the enamel layer can thus be dispensed with, and modified particularly advantageously. As a result a stove-enamelling station and a cooling station for applying the enamel layer are omitted, and instead of this the door pane is heat-treated in an additional heat treatment station, preferably thermally pre-stressed. It has proven particularly beneficial for the impact strength of the door pane if the temperature-time period used in the heat treatment station corresponds to the temperature-time period, used in the stove-enamelling station and in the cooling station during application of the enamel layer to the door pane.

So that this additional heat treatment step can be carried out as simply and as cost-effectively as possible in the abovedescribed heat treatment station, in a particularly simple configuration of the above modified methods the additional heat treatment step is performed in the stove-enamelling station/cooling station, which is also used during application of the enamel layer. Because of this an additional workstation in the form of the heat treatment station can be omitted.

Four embodiments of the invention will now be explained hereinbelow by means of the attached figures, in which:

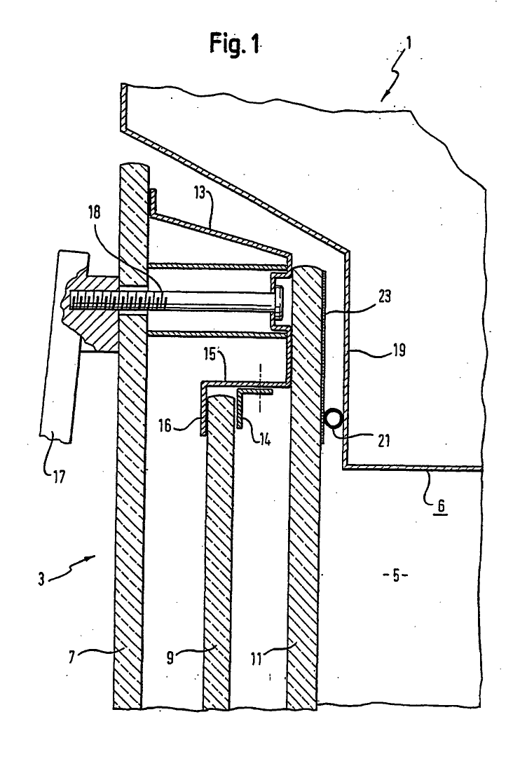

FIG. 1 shows a section of a baking oven in schematic side elevation and in section according to a first embodiment;

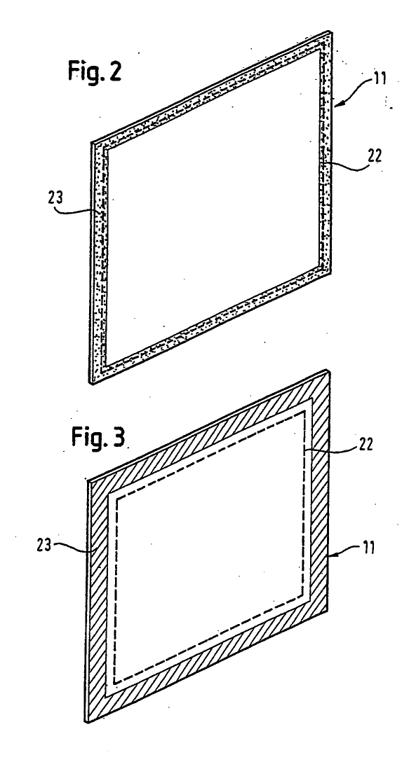

FIG. 2 shows a side elevation of the cooling compartment of the cooking appliance of a door pane shown in FIG. 1;

FIG. 3 shows a view corresponding to FIG. 2 according to a second embodiment;

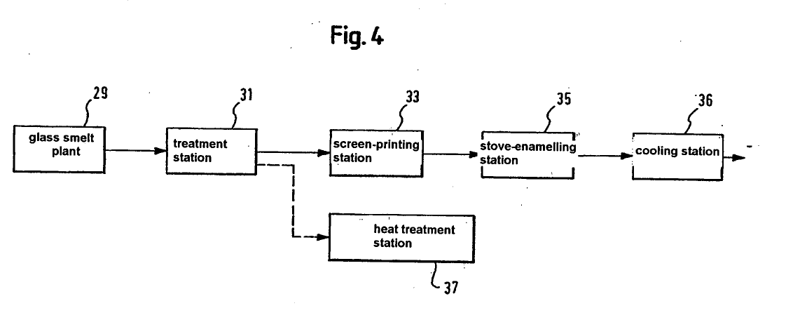

FIG. 4 shows a schematic block diagram of a method for manufacturing a door pane of a cooking appliance door according to a third embodiment; and

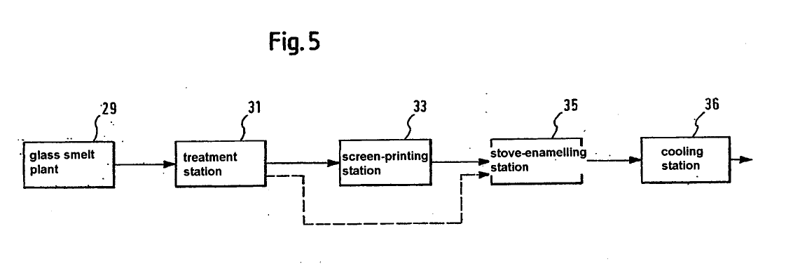

FIG. 5 shows a schematic block diagram of a method for manufacturing a door pane of a cooking appliance door according to a fourth embodiment.

FIG. 1 shows a baking oven 1 according to a first embodiment as a cooking appliance. A baking oven door 3 of the baking oven 1 closes in a cooling compartment 5 open to the front of a cooking appliance muffle 6. The cooking appliance door 3 has three full glass door panes, namely a front door pane 7, a middle door pane 9 and an inner pane 11; at least the inner pane 11 is made of flat borosilicate sheet glass. For fixing the door panes the baking oven door 3 has a door cover 13, formed by a one-piece, frame-like sheet component having a side flange 15, which surrounds a right-angled viewing window in the baking oven door.

Held within this circular side flange 15 is the middle door pane in a mounting arrangement 14, 16. The mounting arrangement according to FIG. 1 an angled profile 14, fastened to the side flange 11, as well as a bit stop 16, formed on the side flange 11. In addition to this the baking oven door 3 has an actuating handle 17, which is tensed in conventional fashion between the front door pane and the door cover 13 by means of a fastening screw 18.

In FIG. 1 the cooling compartment 5 is illustrated closed by means of the inner pane 11 of the baking oven door 1; between a circumferential edge area of the inner pane 11 and the muffle frame 19 is a muffle seal 21, which substantially frames the frontal opening of the cooling compartment 5 and is usually mounted on the muffle frame 19.

As evident from FIG. 1, the inner pane 11 is fitted with an optionally coloured enamel layer 23, which is applied to the side of the inner pane 11 facing the cooking appliance muffle 6. The position of the enamel layer 23 on the door pane 11 is evident from FIG. 2. FIG. 2 shows that the enamel layer 23 extends like a frame in the edge region of the side of the door pane 11 facing the cooking appliance muffle 6. When the baking oven door 1 is open an operator is barred, for optical reasons, from viewing the mounting arrangement 14, 16 of the middle door pane 9 and the head of the fastening screw 18.

The bearing position of the frame-like muffle seal 21 on the enamel layer 23 shown in dashed lines 22 is also shown in dashed lines 22 in FIG. 2. The majority of the enamel layer 23 is arranged outside the limit drawn by the line 22. When the cooling compartment 5 is closed only a minimal portion of the enamel layer 23, according to the present invention less than 5%, is arranged inside the limit drawn by the line 22, and thus arranged inside the closed cooling compartment 5. On the one hand this achieves adequate facing of the door pane 11 when the baking oven door 1 is opened; on the other hand possible evaporation of contaminants contained in the enamel layer into the cooling compartment 5 is prevented or sharply reduced.

The proportion of area of the enamel layer 23 shown in FIG. 2 is approximately in a region of 8 to 10% of the entire surface of the side of the door pane 11 facing the cooking appliance muffle 6. Thus, the surface structure of this side of the door pane is impaired minimally by the enamel layer 23, such that impact strength and the resistance to heat stress during the pyrolysis operation is still sufficiently great, is achieved in spite of adequate facing of the inner pane 11. It is also apparent from FIG. 2 that the enamel layer 23 is not applied to the full surface to the side of the door pane 11, rather it is applied in the form of a raster pattern. This further reduces the proportion of area of the enamel layer 23, and at the same time provides a large faced area.

In FIG. 3 a second embodiment is illustrated, in which the enamel layer 23, as in FIG. 2, is arranged on the side of the inner pane 11 facing the cooking appliance muffle 5. In contrast to FIG. 2 the enamel layer 23 is formed full surface, and extends over approximately 8 to 10% of the entire surface of the door pane side. The entire enamel layer 23 is outside the bearing position of the muffle seal 19 drawn by the line 22 when the baking oven door 1 is closed, and thus also outside the cooling compartment 5 when the baking oven door is closed.

Possible evaporation of contaminants in pyrolysis operation in the cooling compartment 5 is thereby reliably prevented. According to FIG. 3 the muffle seal 21 coming into contact with the enamel layer 23 is also avoided, effectively preventing a chemical reaction between the enamel layer 23 and the muffle seal 21, usually made of silicon, optionally taking place during the pyrolysis operation. In the process, the proportion of possibly evaporating contaminants is clearly below the existing contaminant limit values.

The method for manufacturing the door pane 11 according to the third embodiment is shown in a schematic block diagram in FIG. 4. As a result, in a glass smelting plant 29 a flat borosilicate sheet glass plate is produced in the form of an endless band, which is cut to size, ground and/or bored in a processing station 31 to order by the client, i.e. to the dimensions of the door pane 11. In order to apply the enamel layer 23 to the door pane 11, the enamel layer 23 is applied in a screen-printing station 33 by means of screen-printing stencils, which are produced photographically; a stencil is required for each colour of the enamel layer 23. Next, the enamel layer 23 is baked in the door pane 11 in a stove-enamelling station 35, and cooled in a cooling station 36 by means of a cool-air system.

Insofar as the proportion of area of the enamel layer 23 on the door pane 11 is 0%, then treatment of the door pane 11 in the screen-printing station 33, the stove-enamelling station 35 and the cooling station 36 can be omitted. In such a case, after it is cut to size in the processing station 31, the door pane 11 is introduced to an additional heat treatment station 37 where it is heat-treated to achieve thermal pre-stressing of the door pane 11. In the process the time-temperature period for heating and cooling the door pane 11 applied in the heat treatment station 37 advantageously corresponds substantially to the time-temperature period, used in the stove-enamelling station 35 as well as in the cooling station 36 during application of the enamel layer 23 to the door pane 11.

In contrast to the third embodiment of FIG. 4 in a particularly advantageously modified method according to a fourth embodiment of FIG. 5 the additional heat treatment station 37 is dispensed with. But to carry out the heat treatment step provided in the heat treatment station 37—in the event that the proportion of area of the enamel layer 23 is 0%—the door pane 11 is guided past the screen printing station 33 directly into the stove-enamelling station 35 and the cooling station 36, in which the heat treatment step is performed.

1-11. (canceled)

12. A cooking appliance equipped with a pyrolysis operation comprising a cooking appliance door adapted to close a cooling compartment, said compartment comprising a cooling applance muffle which has an opening to the front of said appliance, said door comprising at least a thermally pre-stressed borosilicate sheet glass door pane, said pane supported by a frontal muffle frame of the cooking appliance muffle when the cooking appliance door is closed, said pane further comprising an enamel layer which covers between 0 and 10% of the area of the door pane.

13. The cooking appliance as defined in claim 12 wherein said enamel layer is arranged on the side of the door pane facing the cooking appliance muffle.

14. The cooking appliance as defined in claim 13 wherein the proportion of the area of the enamel layer which lies within a bearing position to the muffle seal arranged between the door pane and the muffle frame when the cooking appliance door is closed is between about 0 and 5%.

15. The cooking appliance as defined in claim 14 wherein said proportion of area of the enamel layer is averted from the cooking appliance muffle.

16. The cooking appliance as defined in claim 12 wherein said enamel layer is designed as a grid structure having a raster line pattern.

17. A method for manufacturing a door pane for a cooking appliance door adapted for pyrolysis operation, said method comprising providing a flat, thermally pre-stressed borosilicate sheet glass door pane processing said pane through a stove-enameling station wherein an enamel layer is applied to said pane having a proportion of area between 0 and 10% of the door pane, passing said pane through a screen printing station and passing said pane through a cooling station.

18. The method as defined in claim 17 wherein said stove-enameling station and cooling station are substituted by providing a heat treatment station in which the door pane is thermally pre-stressed.

19. The method as defined in claim 18 wherein a temperature-time period for heating and cooling the door pane employed in the heat treatment station corresponds to a temperature-time period which is applied in the stove-enameling station, the cooling station and the station applying the enamel layer to the door pane.

20. The method as defined in claim 18 wherein the heat treatment step provided in the heat treatment station is performed in the stove-enameling station.
